(19) United States
(12) Patent Application Publication
(10) Pub. No.: US 2008/0222611 A1
(43) Pub. Date: Sep. 11, 2008

(54) Generic validation layer for object properties

(75) Inventor: Nitin Sharma, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/716,179

(22) Filed: Mar. 9, 2007

(51) Int. Cl. G06F 9/44

(52) U.S. Cl. 717/126; 719/328

(57) ABSTRACT

A validation layer that facilitates the automatic annotation of object properties by the object with a validation attribute (e.g., FieldValidation), thereby specifying a set of validation rules declaratively, and scenarios under which these validation rules should fire. During build time, the validation layer iterates through each module and associated module classes to automatically generate the validation code. This not only makes the code more readable, but also ensures that a project has consistent validation handling. The validation layer applies to the annotation and validation at the property-level and inter-property. Thus, property-level validation is employed to ensure the correctness of individual values, and inter-property validation can be employed to ensure the correctness in combinations of values.

### BACKGROUND

With the wide variety of software and hardware systems evolving and entering into business and personal usage, it becomes important to ensure that the user experience is as pleasant and productive as possible. For example, if a user experiences problems opening a web page, is it likely that the website vendor will not be able to convey the information desired whether for purely information purposes or to gain a customer through the sale of goods or services.

Code validation is a process of checking if code meets a certain criterion. In the context of web page code, for example, validation can be employed to ensure code interoperability with an open standard for interacting with a large population of potentially disparate software and/or hardware systems.

Business object properties should be validated before being persisted. For example, objects received from different callers such as APIs should be validated before passing the objects to a database or file system to ensure that data passed in association with of those objects is in the correct format. For example, for user objects of a first name and last name, it is desirable to not only ensure that the user has entered data into both fields, but also that the data entered is according to the desired format. Typical validation mechanisms handle properties related to null, maximum length, minimum length, and whether the properties match some criteria.

Adding validation code for each property using conventional methods is very cumbersome and error prone in that the developer writes code (or hard codes) into the application for properties that the developer wants to be validated. Developers (or users) expose the properties and manually assign criteria to the desired properties. Accordingly, where a large amount of code is involved, this process can be extremely time-consuming, inconsistent, and error-filled. Moreover, consider three fields (e.g., first name, last name, and phone number), if the user fails to enter data into the first field (a null condition), the validation process will throw an exception (or error), which is then processed back up to the user interface (UI) prompting the user to address the exception. When the user has corrected the error, validation is again performed on the first field, and if passed, validation processing moves to the second field, and so on. Thus, a large number of validations need to be performed before the object can be used. This is a very time-consuming ordeal that can impact not only the user experience but also system processes that are transparent to the user.

### SUMMARY

The following presents a simplified summary in order to provide a basic understanding of novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a validation layer that facilitates the automatic annotation of object properties of the object with a validation attribute (e.g., FieldValidation), thereby specifying a set of validation rules declaratively and scenarios under which these validation rules should fire.

During build time, the validation layer iterates through each module and associated module classes to automatically generate the validation code. This not only makes the code more readable, but also ensures that a project has consistent validation handling. The validation layer applies to the annotation and validation at the property-level and inter-property. Thus, property-level validation is employed to ensure the correctness of individual values, and inter-property validation can be employed to ensure the correctness in combinations of values.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates data validation.

FIG. 2 illustrates an alternative system that employs validation according to system layers.

FIG. 3 illustrates a general diagram of property annotation for objects of an application module.

FIG. 4 illustrates a method of validation processing.

FIG. 5 illustrates an alternative method of validation processing.

FIG. 6 illustrates a method of validation processing for related property consistency.

FIG. 7 illustrates a block diagram of a computing system operable to execute validation processing in accordance with the disclosed architecture.

FIG. 8 illustrates a schematic block diagram of an exemplary computing environment that validation processing in a client/server environment.

### DETAILED DESCRIPTION

The disclosed architecture is a validation layer that is employed between an application layer and a storage layer for the interception of write operations of data to a database or file system. Using this validation layer, an object can annotate object properties with a validation attribute to declaratively specify a set of validation rules, and the scenarios under which these validation rules should be utilized. During build time, the validation layer then iterates through each object module and the associated object classes, and automatically generates validation code.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

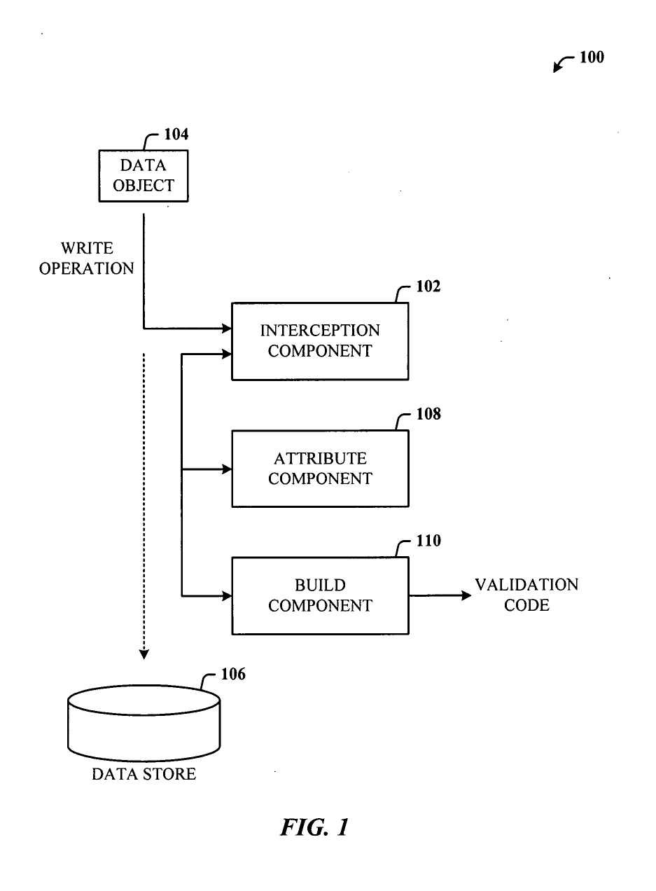

Referring initially to the drawings, FIG. 1 illustrates a computer-implemented system 100 that facilitates data validation. The system 100 includes an interception component 102 for intercepting a write operation of a data object 104 to a data store 106 (or file system). The write operation can occur after a user enters the desired information or string into a field (e.g., a web page). An attribute component 108 automatically tags the data object 104 with a validation attribute. A build component 110 then automatically generates validation code at build time based on the attribute. The validation code can then be processed for exceptions, and the exceptions corrected before the data object is persisted.

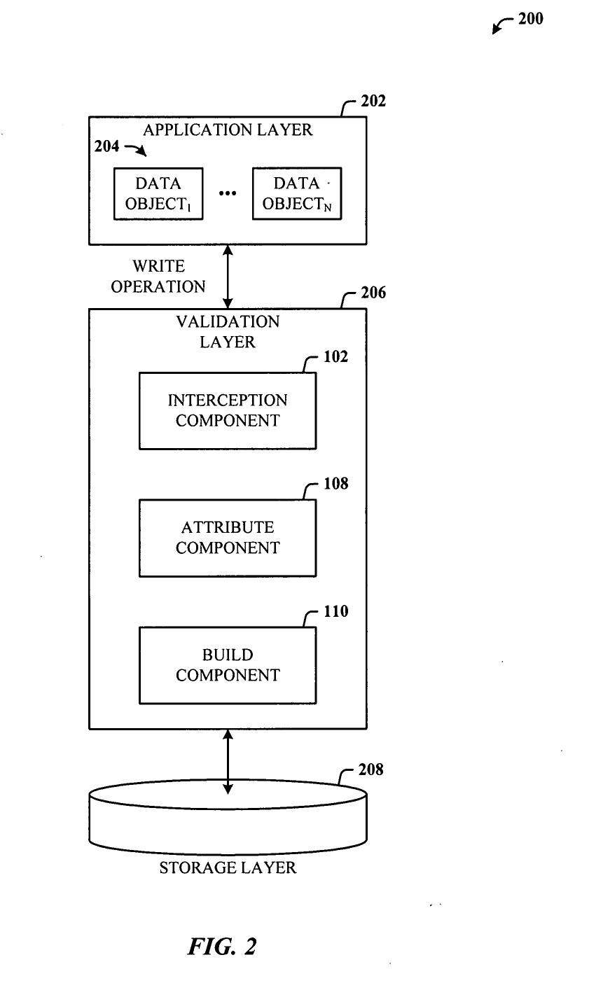

FIG. 2 illustrates an alternative system 200 that employs validation according to system layers. The system 200 includes an application layer 202 via which one or more objects 204 (denoted DATA OBJECT₁, . . . ,DATA OBJECT_{N}, where N is a positive integer) are created and utilized. In accordance with the disclosed architecture, a validation layer 206 is introduced that intercepts write operations from the application layer 202 to a storage layer 208 (e.g., associated with the data store 106 of FIG. 1). The validation layer 206 then processes the data objects as described supra in accordance with the interception component 102, attribute component 108, and build component 110. Accordingly, validation is performed at the object level.

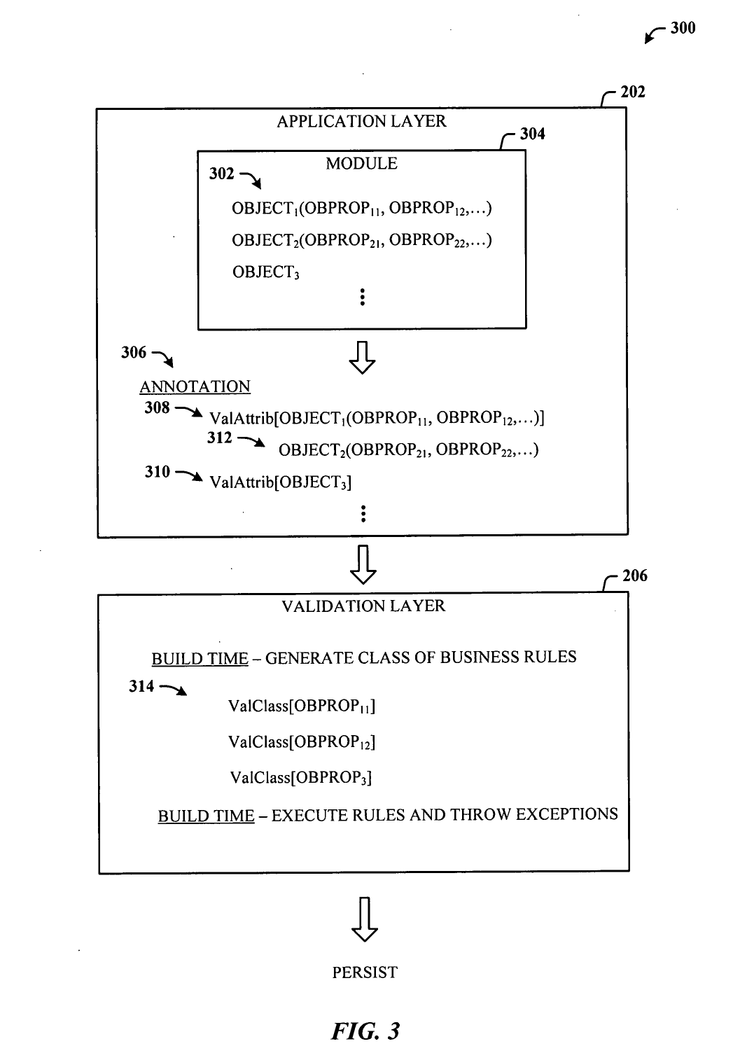

FIG. 3 illustrates a general diagram 300 of property annotation for objects 302 of an application module 304. The module 304 at the application layer 202 can include one or more objects 302, some of which have associated properties. For example, a first object (OBJECT₁) has object properties (denoted OBPROP₁₁,OBPROP₁₂, . . . ). Similarly, a second object can include object properties (denoted OBPROP₂₁,OBPROP₂₂, . . . ). A third object (OBJECT₃) has no properties but can still be tagged for validation.

Annotation of one or more of the objects 302 can occur at the application layer 202. Here, the first object 308 and third object 310 are annotated with a ValAttrib for validation processing, but the second object 312 is not annotated. In another implementation, all of the objects 302 are automatically annotated for validation processing.

When the objects 302 and associated data are to be persisted, the validation layer 206 intercepts the write process and iterates through each module and the module classes, and generates the validation code. Accordingly, at build time, the annotated objects (308 and 310) and properties are processed into rules 314. The rules are then processed and exceptions generated, where necessary. Once all exceptions have been cleared, the objects can be persisted.

Following is exemplary code that illustrates the annotation and validation processes described herein. Consider a project that wants to use the services of the validation layer includes a Validation Helper DLL (dynamic link library). The Helper DLL implements a custom attribute called FieldValidationAttribute. Classes then apply the above attribute and implement an ICustomValidator interface to enforce validation rules.

```
public class Address : ICustomValidator
{
      [FieldValidation(MaxLength = 16)]
        public string AddressId
        {
            get {return addressId ;}
            set {addressId=value;}
        }
        [FieldValidation(IsRequiredForInsert = true,
IsRequiredForUpdate = true, MaxLength = 64)]
        public string FriendlyName
        {
            get {return friendlyName;}
            set {friendlyName=value;}
        }
        [FieldValidation(IsRequiredForInsert = true,
IsRequiredForUpdate = true, MaxLength = 128)]
        [FieldValidation(MinLenth=6)]
        public string Street1
        {
            get {return street1;}
            set { street1=value;}
        }
      .....
      public EcommerceErrorCollection CustomValidate(bool isCreate,
string providerName)
        {
      }
}
```

In the example above, a new class called Address is defined. A field validation attribute FieldValidation is applied to MaxLength=16; thus, a user passing this field will be limited to 16 units. Accordingly, when inputting information into a database where the database expects data no longer than 16 units, the validation layer will check this prior to the data reaching the database. As shown above, FieldValidation is assigned to IsRequiredForInsert=true, and other object properties. Because these properties are annotated, insertion of this object into a database can only be accomplished when the fields are there.

During the build process, validation code is generated for classes that annotate properties with FieldValidation validation attribute. The auto-generated class as follows:

```
public class AddressInfoValidator : IValidator
  {
    public EcommerceErrorCollection Validate( object profile,
bool isCreate, string providerName)
    {
  Microsoft.OfficeLive.ECommerce.AccountManagement.AddressInfo
source =
(Microsoft.OfficeLive.ECommerce.AccountManagement.
AddressInfo)profile;
      EcommerceErrorCollection validationErrors = new
EcommerceErrorCollection( );
  ValidationClass.Instance.ValidateMaxLength(source.AddressId,16,
“AddressId”, ref validationErrors);
  ValidationClass.Instance.ValidateRequiredForInsertFieldValiation
(source.FriendlyName, “FriendlyName”, isCreate,ref validationErrors);
  ValidationClass.Instance.ValidateRequiredForUpdateField-
Valiation(source.FriendlyName, “FriendlyName”, !isCreate,ref
validationErrors);
  ValidationClass.Instance.ValidateMaxLength(source.FriendlyName,
64,“FriendlyName”, ref validationErrors);
  ValidationClass.Instance.ValidateRequiredForInsertField-
Valiation(source.Street1,“Street1”, isCreate,ref validationErrors);
  ValidationClass.Instance.ValidateRequiredForUpdateField-
Valiation(source.Street1,“Street1”, !isCreate,ref validationErrors);
  ValidationClass.Instance.ValidateMaxLength(source.Street1,128,“
Street1”, ref validationErrors);
  ValidationClass.Instance.ValidateCustomValidation(profile,
isCreate, providerName, ref validationErrors);
      return validationErrors;
    }
  }
```

Before persisting the objects, the user can call an API from the Validation Helper DLL, ValidateProfile, for example, as illustrated by the following exemplary code:

static public void ValidateProfile(IProfileType profile, bool
isCreate, string profileproviderName)

The above API executes all of the business rules and throws exceptions for validation failures.

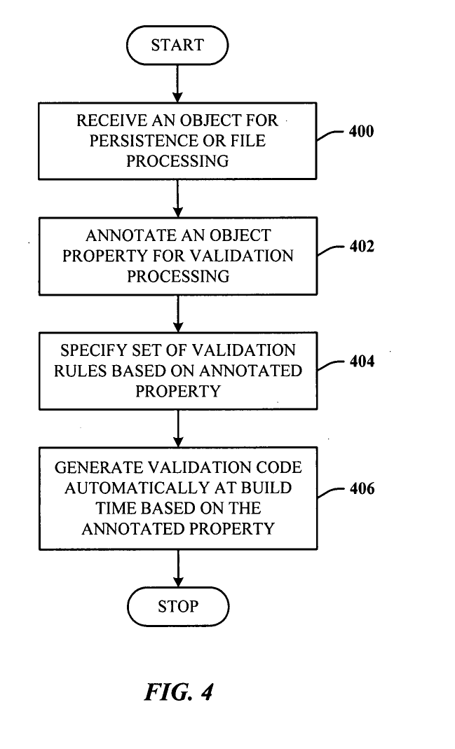

FIG. 4 illustrates a method of validation processing. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 400, an object is received for persistence or file processing. At 402, an object property of the object is annotated for validation processing. At 404, a set of validation rules are specified based on the annotated property. At 406, validation code is automatically generated at build time based on the annotated object property.

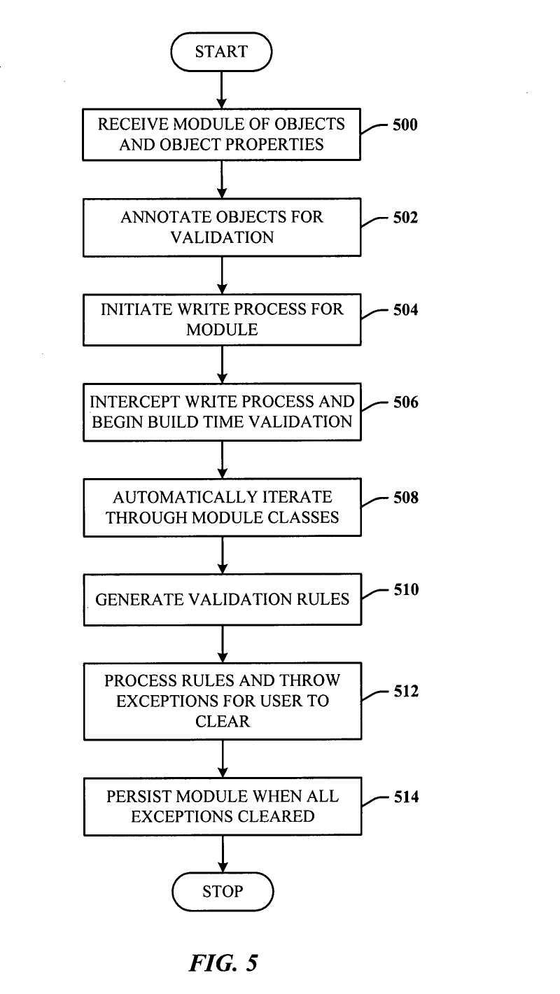

FIG. 5 illustrates an alternative method of validation processing. At 500, a module of objects and object properties is received. At 502, the desired objects are annotated (or tagged with a validation tag). At 504, a write process is initiated for storing the module and/or module objects (and data). At 506, the write process is intercepted and build-time validation initiated. At 508, the system automatically iterates through the module classes. At 510, validation rules are generated from the iteration process. At 512, the rules are then processed, and exceptions thrown (or errors generated) for a user to clear. At 514, the module is persisted once the user has cleared all exceptions.

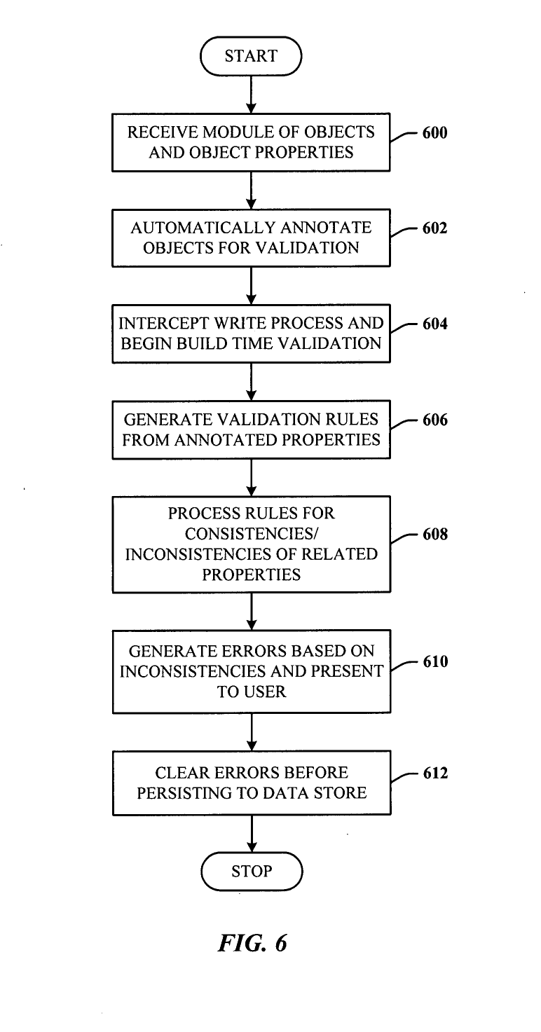

FIG. 6 illustrates a method of validation processing for related property consistency. At 600, a module of objects and object properties is received. At 602, the objects are automatically annotated for validation. At 604, a write process is intercepted and build-time validation begins. At 606, validation rules are generated from the annotated properties. At 608, the rules are processed for consistencies or inconsistencies between related properties. In other words, if a field requires entry of a city, entry of the state data should be consistent with the city. This can be carried further to also check for consistency with a zip code, and/or an address, for example. At 610, errors are generated based on the inconsistencies, and presented to a user. Note that the user can be a human perceiving the errors via a UI, or another system process to which the errors are sent for processing. At 612, the errors are cleared before the data is persisted to a data store.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

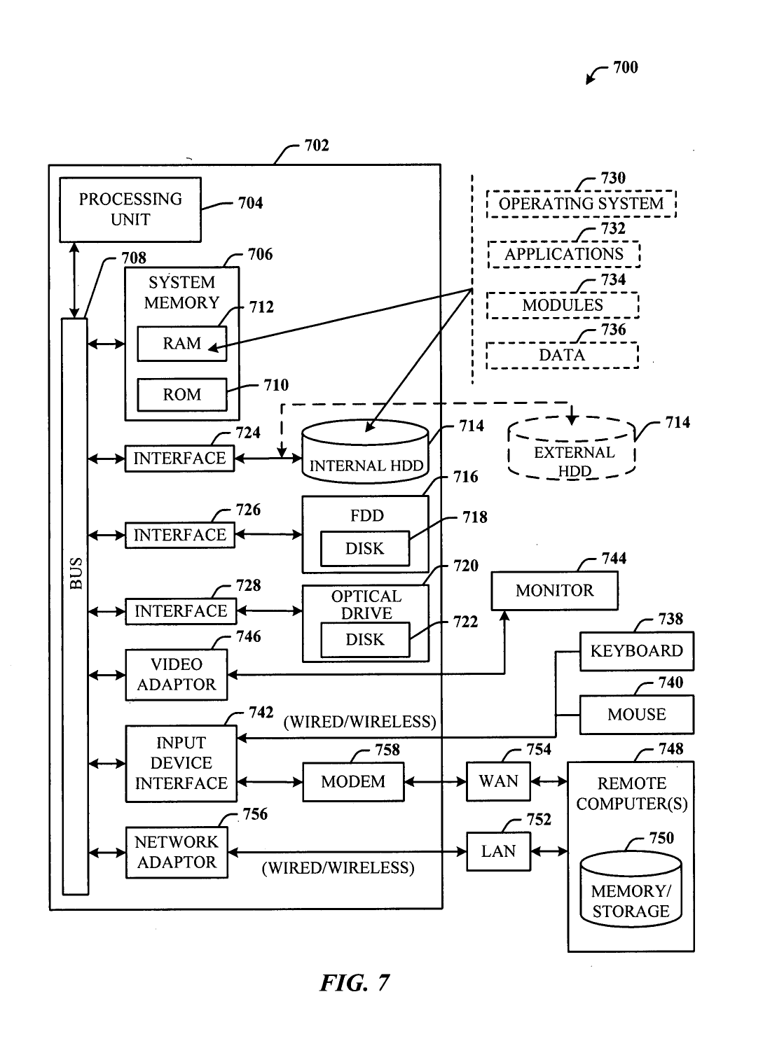

Referring now to FIG. 7, there is illustrated a block diagram of a computing system 700 operable to execute validation processing in accordance with the disclosed architecture. In order to provide additional context for various aspects thereof, FIG. 7 and the following discussion are intended to provide a brief, general description of a suitable computing system 700 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 7, the exemplary computing system 700 for implementing various aspects includes a computer 702, the computer 702 including a processing unit 704, a system memory 706 and a system bus 708. The system bus 708 provides an interface for system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 712, including an operating system 730, one or more application programs 732, other program modules 734 and program data 736. All or portions of the operating system, applications, modules, and/or data can also be cached in the RAM 712. It is to be appreciated that the disclosed architecture can be implemented with various commercially available operating systems or combinations of operating systems.

The modules 734 can include the interception component 102 for intercepting a write process, the attribute component 108 for tagging objects and/or object properties, and the build component 110 for the processing of the validation rules at build time.

A user can enter commands and information into the computer 702 through one or more wired/wireless input devices, for example, a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the local network 752 through a wired and/or wireless communication network interface or adapter 756. The adaptor 756 may facilitate wired or wireless communication to the LAN 752, which may also include a wireless access point disposed thereon for communicating with the wireless adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

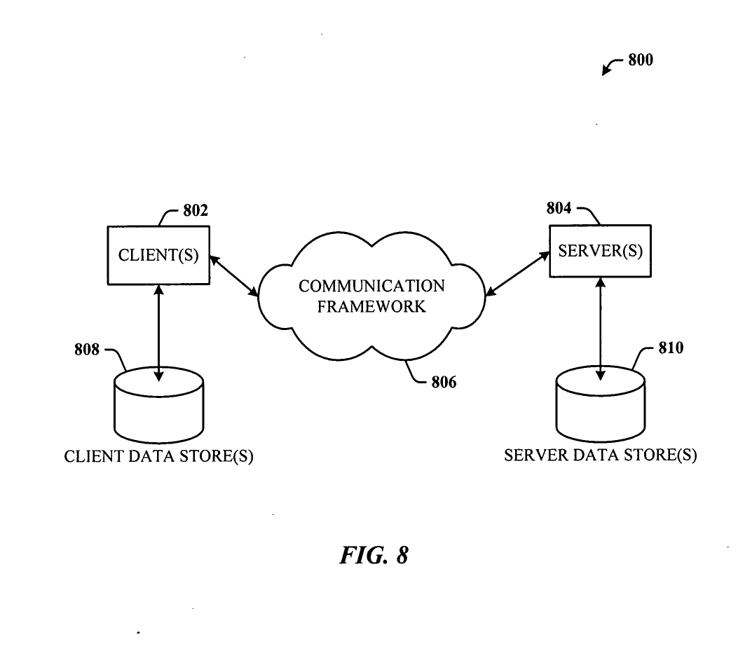

Referring now to FIG. 8, there is illustrated a schematic block diagram of an exemplary computing environment 800 that validation processing in a client/server environment. The system 800 includes one or more client(s) 802. The client(s) 802 can be hardware and/or software (e.g., threads, processes, computing devices). The client(s) 802 can house cookie(s) and/or associated contextual information, for example.

The system 800 also includes one or more server(s) 804. The server(s) 804 can also be hardware and/or software (e.g., threads, processes, computing devices). The servers 804 can house threads to perform transformations by employing the architecture, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

The clients 802 can include the application modules having object and object properties which can be persisted to the client data stores 808. Alternatively, or in combination therewith, the validation processing can be in preparation for storing data of the client on the server data stores 810.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates data validation, comprising:
an attribute component for tagging a data object with a validation attribute based on a write operation for the data object; and
a build component for automatically generating validation code at build time based on the attribute.

2. The system of claim 1, wherein the build component processes the validation code for exceptions.

3. The system of claim 2, wherein the data object is stored in a data store after the exceptions are cleared.

4. The system of claim 1, wherein the build component calls an application program interface (API) to execute the validation code for exceptions.

5. The system of claim 4, wherein the API executes the validation code for inconsistencies between related properties of the data object.

6. The system of claim 1, wherein the data object includes properties related to at least one of a null, a maximum length, minimum length, or matching criteria.

7. The system of claim 1, wherein the attribute component selectively tags the data object from a plurality of data objects.

8. The system of claim 1, further comprising an interception component for intercepting the write operation associated with writing the data object to a data store.

9. A computer-implemented method of validating data, comprising:
annotating an object property of an object with a validation attribute;
specifying a set of validation rules based on the annotated property; and
automatically generating validation code at build time based on the annotated property.

10. The method of claim 9, further comprising annotating the object property, specifying the set of validation rules, and generating the validation code in response to receiving the object for persistence.

11. The method of claim 9, further comprising automatically annotating the object property for validation of a null.

12. The method of claim 9, further comprising automatically annotating the object property for validation of a maximum string length.

13. The method of claim 9, further comprising automatically annotating the object property for validation of a minimum string length.

14. The method of claim 9, further comprising generating the validation code during a build process for classes that have an annotated property.

15. The method of claim 9, further comprising calling an API for executing a business rule prior to persisting the object.

16. The method of claim 9, further comprising calling an API for generating an exception based on a validation failure.

17. The method of claim 9, further comprising automatically creating the object based on data entry into a property field.

18. The method of claim 9, further comprising:
intercepting a save operation;
processing the object through filtering rules; and
generating an exception based on failed validation of the object property.

19. The method of claim 9, further comprising checking consistency between two or more object properties as part of a validation process.

20. A computer-implemented system, comprising:
computer-implemented means for annotating an object of an application module with a validation attribute;
computer-implemented means for specifying a set of validation rules based on the annotated object; and
computer-implemented means for automatically generating validation code at build time based on the annotated object.
